(19) United States
(12) Patent Application Publication
(10) Pub. No.: US 2020/0339378 A1
(43) Pub. Date: Oct. 29, 2020

(54) SYSTEMS AND METHODS FOR APPLYING A BRAKE FORCE DURING WITHDRAWAL OF MATERIAL FROM A BOBBIN

(71) Applicant: Bartell Machinery Systems, L.L.C., Rome, NY (US)

(72) Inventors: Andrew W. Beck, Glenside, PA (US); Joseph C. Blandino, Bronx, NY (US); Remo J. Colarusso, III, Bridgewater, NJ (US); Kenneth Raymond Johnson, Newport, RI (US); Matthew J. Wolfanger, Camillus, NY (US); Rodney Joseph Willson, Ava, NY (US)

(73) Assignee: Bartell Machinery Systems, L.L.C., Rome, NY (US)

(21) Appl. No.: 16/397,197

(22) Filed: Apr. 29, 2019

(51) Int. Cl. B65H 59/38; F16D 49/00; B65H 54/02

(52) U.S. Cl. CPC B65H 59/382; F16D 2121/14; B65H 54/02; F16D 49/00

(57) ABSTRACT

In one embodiment, a system for imparting a force during operation of a wire bobbin comprises a main shaft for receiving a wire bobbin, and a brake element operably coupled to the main shaft. The system may further comprise an adjustment assembly comprising an adjustment block and at least one adjustment spring, wherein the at least one adjustment spring is biased to provide a force on the adjustment block in a vertically-upward direction. The adjustment block may be operably coupled to the main shaft, such that a mass of the main shaft imposed upon the adjustment block combined with resistance of the at least one adjustment spring determines a vertical position of the main shaft and the brake element. A brake assembly may provide a brake force on the brake element, wherein the brake force is imparted to the main shaft via the brake element.

### BACKGROUND

The present embodiments relate generally to systems and methods for controlled release of material, such as wire, from a bobbin in an improved manner.

In many wire stranding applications, such as tubular stranders and pay-offs, wire is withdrawn from a bobbin. The wire is initially disposed on the bobbin in a fuller state, in which the bobbin comprises a first mass and the wire may comprise a first diameter around the bobbin. As the wire is withdrawn from the bobbin during operation, the bobbin comprises a second mass that is less than the first mass, and further may comprise a second diameter around the bobbin that is less than the first diameter.

In prior known systems, there is often a varying tension applied to the wire as it is withdrawn from the bobbin. Without actively attempting to regulate tension, there may be too much or too little tension as wire is withdrawn when the bobbin is relatively full versus when the bobbin is relatively empty. With too much or too little tension on the wire, an end product downstream may be compromised.

Prior attempts to regulate tension as wire is withdrawn from a bobbin have included electrical or pneumatic inputs. Such inputs may yield cost and complexity to the system. Further, additional components, such as slip rings, rotary unions, batteries and the like, may be required with such systems.

Moreover, slip rings, rotary unions, and the like may be difficult to operate for high speed systems, e.g., operating at up to 3,100 rpm. Downtime and maintenance concerns arise with the addition of such components, particularly at such high operational speeds.

### SUMMARY

In one embodiment, a system for imparting a force during operation of a wire bobbin comprises a main shaft for receiving a wire bobbin, and a brake element operably coupled to the main shaft. The system may further comprise an adjustment assembly comprising an adjustment block and at least one adjustment spring, wherein the at least one adjustment spring is biased to provide a force on the adjustment block in a vertically-upward direction. The adjustment block may be operably coupled to the main shaft, such that a mass of the main shaft imposed upon the adjustment block combined with resistance of the at least one adjustment spring determines a vertical position of the main shaft and the brake element. A brake assembly may provide a brake force on the brake element, wherein the brake force is imparted to the main shaft via the brake element.

In one embodiment, the brake element may comprise a brake disk that is fixed relative to the main shaft such the brake disk rotates when the main shaft rotates. The brake assembly may comprise a vertically-movable brake pad and at least one brake spring, wherein the brake spring provides a brake force on the brake pad such that the brake pad engages the brake disk.

A support rod may be coupled to the brake pad. The support rod may have a first region coupled to a fixed segment of a cradle, and a second region coupled to the brake pad. The brake spring may be disposed around the support rod between the fixed segment of the cradle and the brake pad. The fixed segment of the cradle may be disposed vertically beneath the brake disk, such that the brake spring is biased to provide an upward force upon the brake pad to engage the brake disk.

The adjustment assembly may comprise at least one guide having a first region coupled to a fixed segment of a cradle. The guide may extend through an aperture of the adjustment block such that the adjustment block is vertically movable along the guide. The adjustment spring may be disposed around the guide between the fixed segment of the cradle and the adjustment block. In one embodiment, the adjustment assembly may comprise first and second guides disposed in a spaced-apart relation to one another, wherein each of the first and second guides extends through a respective aperture of the adjustment block.

In one embodiment, the adjustment assembly is positioned laterally outside of the brake element. Further, a locking collar may be coupled to the main shaft and configured to secure the bobbin in a lateral position along a length of the main shaft.

In an exemplary method for imparting a force during operation of a wire bobbin, a step comprises providing a wire bobbin disposed around a main shaft, wherein the main shaft is coupled to an adjustment assembly comprising an adjustment block and at least one adjustment spring. A mass of the main shaft imposed upon the adjustment block combined with resistance of the at least one adjustment spring determines a vertical position of the main shaft. The method includes operating the wire bobbin in a first operational state, wherein there is a first quantity of wire around the bobbin in the first operational state, and wherein a first brake force is imparted to the main shaft in the first operational state. The method further includes operating the wire bobbin in a second operational state, wherein there is a second quantity of wire around the bobbin in the second operational state, the second quantity of wire being less than the first quantity due to withdrawal of wire from the bobbin. A second brake force is imparted to the main shaft in the second operational state, the second brake force being less than the first brake force.

Other systems, methods, features and advantages of the invention will be, or will become, apparent to one with skill in the art upon examination of the following figures and detailed description. It is intended that all such additional systems, methods, features and advantages be within the scope of the invention, and be encompassed by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is an elevated perspective view of a first embodiment of system for applying a brake force during withdrawal of wire from a bobbin.

FIG. 2 is a top view of the system of FIG. 1.

FIG. 3 is a side view of the system of FIG. 1.

FIG. 4 is a rear sectional view of the system of FIG. 1.

FIG. 5 is a perspective view of the system of FIG. 1 with the bobbin removed to view underlying components.

FIGS. 6A-6B are schematic rear sectional views of the system of FIG. 1 with the bobbin removed in first and second operational states, respectively.

### DETAILED DESCRIPTION OF THE PREFERRED EMBODIMENTS

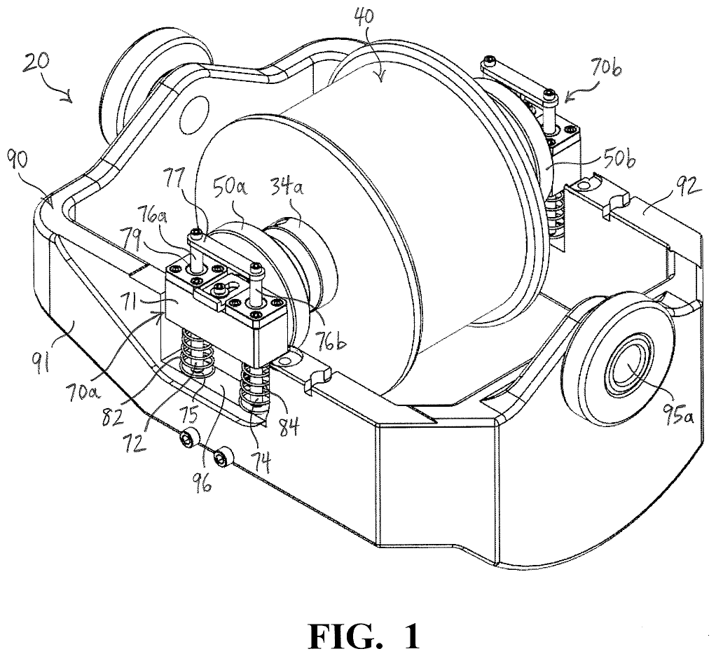

Referring to FIGS. 1-4, a first embodiment of a system 20 for applying a brake force during withdrawal of material, such as wire, from a bobbin is shown and described. The system 20 comprises a main shaft 30 around which a bobbin 40 is disposed. The system 20 further comprises at least one brake element 50 and at least one adjustment assembly 70, which are explained in further detail below. The components of the system 20 may be at least partially contained within, or otherwise coupled to, a cradle 90 that provides a housing or attachment points for the operation of the components.

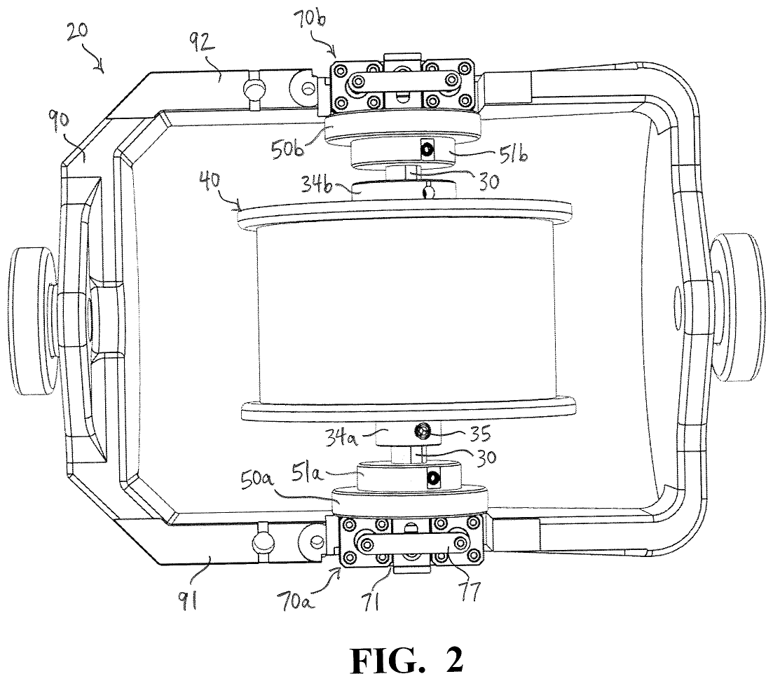

The main shaft 30 extends in a direction laterally between first and second sides 91 and 92 of the cradle 90, as depicted in FIG. 2. The main shaft 30 is operably coupled to the at least one adjustment assembly 70, as explained further below.

At least one locking collar may be used to secure the bobbin 40 in a lateral position along a length of the main shaft 30. In the embodiment of FIGS. 1-4, first and second locking collars 34a and 34b are secured to the main shaft 30 on opposing sides of the bobbin 40. The first and second locking collars 34a and 34b may comprise a set screw 35, which is used to secure and release the lateral position of the collars 34a and 34b. The position of the locking collars 34a and 34b may be adjusted to accommodate bobbins of different widths. In one embodiment, the first and second locking collars 34a and 34b may comprise radially-inward protrusions (not shown) that are adapted to engage recesses in the bobbin 40 to secure the position of the bobbin 40 and facilitate simultaneous rotational movement between the bobbin 40 and the first and second locking collars 34a and 34b.

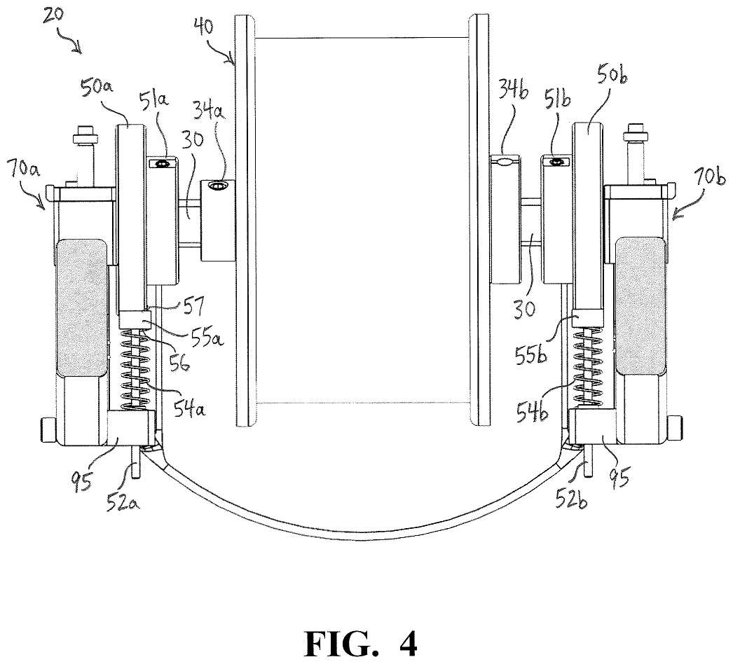

In one embodiment, the at least one brake element 50 comprises a brake disk that is positioned along the lateral length of the main shaft 30. In the embodiment of FIGS. 1-4, first and second brake disks 50a and 50b are provided, with the first brake disk 50a being disposed laterally outside of the first locking collar 34a at a location closer to the first side 91 of the cradle 90, and with the second brake disk 50b being disposed laterally outside of the second locking collar 34b at a location closer to the second side 92 of the cradle 90, as best seen in FIGS. 2 and 4.

The brake element 50 may further comprise a hub 51a, which is disposed adjacent to the brake disk 50a, as best seen in FIG. 4. The hub 51a may comprise an outer diameter smaller than the brake disk 50a, and may comprise a set screw that allows the lateral placement of the brake disk 50a to be adjusted. When the set screw of the hub 51a is secured, the placement of the brake disk 50a is secured. An identical hub 51b may be disposed adjacent to the brake disk 50b for the same purpose, as depicted in FIG. 4.

In this manner, the brake disks 50a and 50b may be fixed relative to the main shaft 30, such that when the main shaft 30, collars 34a and 34b, and the bobbin 40 rotate collectively, then the brake disks 50a and 50b will also rotate together with these components.

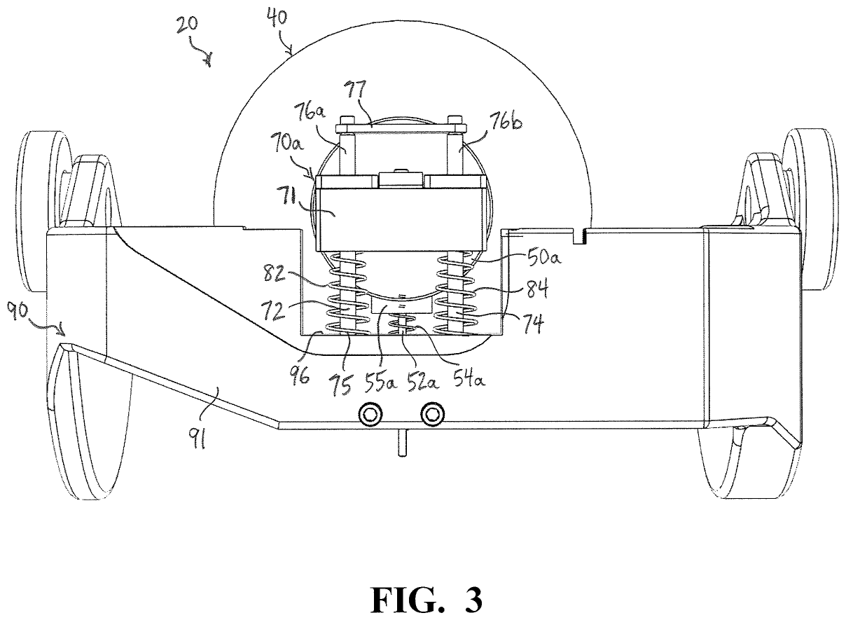

As best seen in FIGS. 3-4, a first brake pad 55a is disposed adjacent to the first brake disk 50a, while a second brake pad 55b is disposed adjacent to the second brake disk 50b. First and second support rods 52a and 52b have lower regions that are secured to segments 95 of the cradle 90 at locations generally beneath the first and second brake disks 50a and 50b, respectively. Further, upper regions of the first and second support rods 52a and 52b are secured to the first and second brake pads 55a and 55b, respectively. In this manner, the first brake pad 55a is positioned adjacent to the first brake disks 50a, while the second brake pad 55b is positioned adjacent to the second brake disk 50b, as shown in FIGS. 3-4.

In the present embodiment, a first spring member 54a encircles the first support rod 52a, while a second spring member 54b encircles the second support rod 52b, as depicted in FIG. 4. Lower ends of the spring members 54a and 54b are positioned vertically adjacent to segment 95 of the cradle 90, while upper ends of the spring members 54a and 54b are positioned vertically adjacent to the first and second brake pads 55a and 55b, respectively, as seen in FIG. 4. As will be explained in further detail below, the spring members 54a and 54b will be compressed or relaxed based on different states of withdrawal of wire from the bobbin 40.

The at least one adjustment assembly 70 may comprise first and second adjustment assemblies 70a and 70b. In the embodiment of FIGS. 1-4, the first adjustment assembly 70a is positioned laterally outside of the first brake disk 50a, while the second adjustment assembly 70b is positioned laterally outside of the second brake disk 50b.

Each of the first and second adjustment assemblies 70a and 70b may comprise a first guide 72, and a second guide 74 disposed in a spaced-apart relation to the first guide 72, as best seen in FIG. 1. In one embodiment, the first and second guides 72 and 74 are in the form of a generally vertical shaft, each comprising a lower region 75 that is secured to the first side 91 of the cradle 90, as depicted in FIG. 1. The first and second guides 72 and 74 also comprise upper regions 76a and 76b, respectively, which may be secured together using a support 77. Although the first and second guides 72 and 74 are in the form of a generally vertical shaft in this embodiment, in alternatives the guide may comprise T-slots, rails, or other guiding structures.

An adjustment block 71 is disposed for vertical movement along the first and second guides 72 and 74 of each of the adjustment assemblies 70a and 70b. The adjustment block 71 may comprise apertures 79, through which the first and second guides 72 and 74 extend. Apertures 79 are sized to permit vertical movement of the adjustment block 71 up and down along the first and second guides 72 and 74, as explained further below.

The adjustment assemblies 70a and 70b each further comprise at least one spring member. In the present embodiment, a first spring member 82 encircles the first guide 72, while a second spring member 84 encircles the second guide 72, as depicted in FIG. 1. Lower ends of the spring members 82 and 84 are positioned vertically adjacent to a ledge 96 of the cradle 90, while upper ends of the spring members 82 and 84 are positioned vertically adjacent to the adjustment block 71, as seen in FIG. 1.

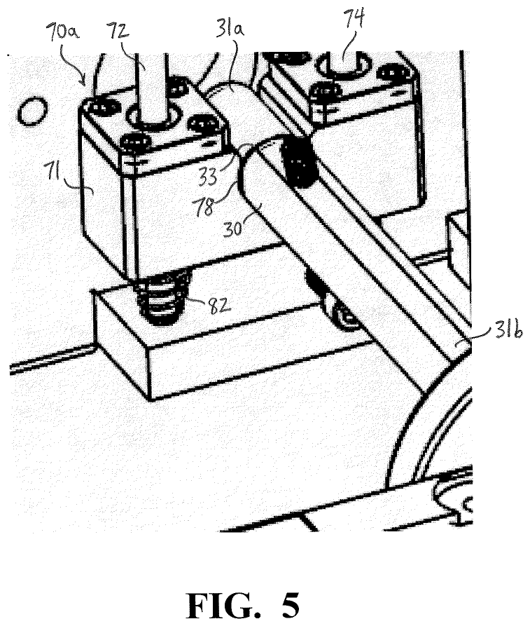

The main shaft 30 has a first region 31a operably coupled to the adjustment block 71 of the first adjustment assembly 70a, and a second region 31b operably coupled to the opposing adjustment block of the second adjustment assembly 70b, as partially depicted in FIG. 5. It is noted that, in FIG. 5, the bobbin 40, locking collar 34a and first brake disk 50a are removed for illustrative purposes. The adjustment blocks 71 of the first and second adjustment assemblies 70a and 70b may each comprise recesses 78 that are sized to receive an outer diameter of the main shaft 30. The main shaft 30 may be held within the recesses 78 of the adjustment assemblies 70a and 70b by providing a stepped ledge 33, which transitions the main shaft 30 from a larger diameter disposed more centrally to a smaller diameter disposed within the adjustment assemblies 70a and 70b. At least one bearing may be provided in the area of the stepped ledge 33 to allow the main shaft 30 to rotate within the adjustment block 71.

It will be appreciated that other coupling mechanisms may be used to secure the first and second regions 31a and 31b of the main shaft 30 to the adjustment blocks 71. Notably, the first and second regions 31a and 31b of the main shaft 30 need not be fully encircled at their uppermost regions, or even their upper halves, by the adjustment blocks 71, although in alternative embodiments full encirclement may be provided.

During use, a bobbin 40 that is full of wire may be loaded onto the main shaft 30. As generally explained above, the first and second locking collars 34a and 34b may be secured laterally using the set screw 35, while the radially-inward protrusions of the locking collars 34a and 34b engage recesses in the bobbin 40. In this manner, the bobbin 40 is secured to the main shaft 30 and will rotate simultaneously with the main shaft 30 and the first and second locking collars 34a and 34b.

In a next step, wire is pulled from the bobbin 40 and directed to a downstream location. The wire may be pulled from the bobbin 40 due to actuation of downstream components, depending on the particular operation of the wire. For example, in one embodiment where the wire is used to form a cable, the wire may be pulled from the twist point where multiple wires are pulled together to form the cable. In this non-limiting example, a series of individual wires from different bobbins 40 may meet at the downstream location for coupling together, e.g., using a lay plate and known equipment.

In a first operational state, when the bobbin 40 is relatively full of wire, the bobbin 40 will comprise a first mass, which may be the greatest during the operational sequence. Moreover, the wire will generally exit the bobbin 40 at a first radial position, which is the largest radial tangent to the bobbin 40.

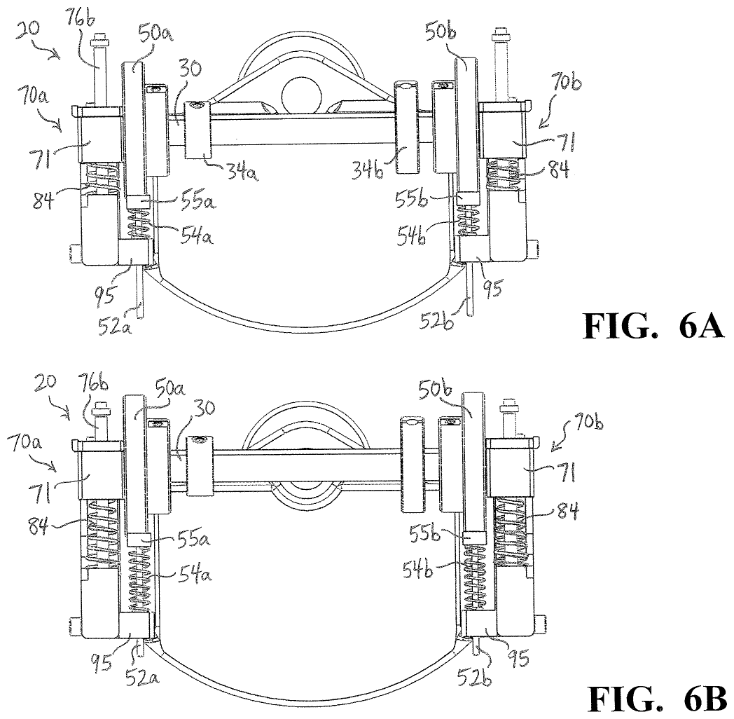

FIG. 6A is a schematic rear sectional view of the system of FIG. 1 in the first operation state, with the bobbin removed for illustrative purposes. In the first operational state, the first and second spring members 82 and 84 of each of the adjustment assemblies 70a and 70b will be in a relatively compressed state, as depicted in FIG. 6A. The compression is due to the relatively high mass of the bobbin 40 being full of wire, which urges the main shaft 30 in a downward direction. Since the first and second regions 31a and 31b of the main shaft 30 are secured within recesses 78 of the adjustment blocks 71, as depicted in FIG. 5, the adjustment blocks 71 are urged vertically downward, and they compress the first and second spring members 82 and 84. The first and second spring members 82 and 84 will ultimately provide resistance to balance out the downward forces, thereby establishing a vertical position of the main shaft 30, the bobbin 40, and the brake disks 50a and 50b.

In this first operational state, the established vertical position of the brake disks 50a and 50b causes the spring members 54a and 54b of the brake assemblies to assume a relatively compressed state, as depicted in FIG. 6A. The spring members 54a and 54b of the brake assemblies have a weaker force relative to the first and second spring members 82 and 84 of the adjustment assemblies. As the brake disks 50a and 50b are urged downward, the adjacent brake pads 55a and 55b are also urged downward. Notably, the first and second spring members 54a and 54b apply a force against the brake pads 55a and 55b during this process that urges the brake pads 55a and 55b into contact with the brake disks 50a and 50b, as shown in FIG. 6A.

When the spring members 54a and 54b assume the relatively compressed state, in the first operational state when the bobbin 40 is relatively full of wire, then the spring members 54a and 54b will cause the brake pads 55a and 55b to impart a relatively high force upon the brake disks 50a and 50b. Since the brake disks 50a and 50b are secured to the main shaft 30, the relatively high force is imparted to the main shaft 30 during its rotation. In effect, when the bobbin 40 is relatively full of wire, a relatively high force is imparted to the main shaft 30 during its rotation.

In a second operational state, as depicted in FIG. 6B, wire is withdrawn from the bobbin 40, and therefore the bobbin 40 will comprise a second mass, which will be less than the first mass during the first operational state. Moreover, in the second operational state, the wire will generally exit the bobbin 40 at a second radial position, which has a smaller radial tangent relative to the bobbin 40, or alternatively stated is more centralized since the bobbin 40 is less full of wire.

In the second operational state, the first and second spring members 82 and 84 of each of the adjustment assemblies 70a and 70b will be in a relatively relaxed state in which they are allowed to expand further, as shown in FIG. 6B. In particular, due to the lower mass of the bobbin 40, the main shaft 30 applies less forced upon the adjustment blocks 71, and therefore the first and second spring members 82 and 84 are more relaxed (or expanded) relative to the first operational state.

In the second operational state, the first and second spring members 54a and 54b disposed adjacent to the brake pads 55a and 55b, respectively, are also in a relative relaxed or expanded state, as depicted in FIG. 6B. As the main shaft 30 is moved upward due to the lessened weight of the bobbin, the brake disks 50a and 50b also rise vertically. When the spring members 54a and 54b assume the relatively relaxed or expanded state, then the spring members 54a and 54b will cause the brake pads 55a and 55b to impart a relatively low force upon the brake disks 50a and 50b. Since the brake disks 50a and 50b are secured to the main shaft 30, the relatively low force is imparted to the main shaft 30 during its rotation. In effect, when the bobbin 40 is less full of wire, a relatively low force is imparted to the main shaft 30 during its rotation.

Advantageously, using the systems and methods described above, a substantially constant tension may be imparted upon the wire as it exits the bobbin 40. More specifically, in the first operational state, the bobbin 40 is relatively full of wire that will generally exit the bobbin 40 at a first radial position having the largest radial tangent to the bobbin 40. This first operational state is inclined to produce a relatively high torque due to the largest radial tangent, and such relatively high torque may be inclined to press on the main shaft 30 the hardest and/or increase rotation of the bobbin 40. However, due to the provision of the components noted above (and balancing spring systems in particular), a relatively high force is imparted to the main shaft 30 during its rotation in the first operational state. Thus, although a relatively high torque is present, the braking force is also relatively high in this first operational state, leading to a predetermined tension imparted upon the wire.

Moreover, this predetermined tension remains essentially the same in the second operational state where the bobbin 40 is less full of wire. In this second operational state, the wire will exit the bobbin 40 at a second radial position having a lesser radial tangent to the bobbin 40. This second operational state is inclined to produce a lower torque due to the lower radial tangent, and such lower torque may be inclined to reduce rotation of the bobbin 40. However, due to the provision of the components noted above, a relatively low force is imparted to the main shaft 30 during its rotation in the second operational state. Thus, although a relatively low torque is present, the braking force is also relatively low in this second operational state, leading to a substantially constant tension imparted upon the wire.

Accordingly, the system 20 regulates wire tension as wire is withdrawn from the bobbin 40, such that a substantially constant tension is imparted to the wire in both the first and second operational states. Moreover, the regulation in tension occurs throughout the entire withdrawal of the wire from the bobbin 40, since mass variations of the bobbin 40 due to wire withdrawal yield changes in the position of the adjustment blocks 71 and consequently the brake force being applied to the main shaft 30. In contrast, in prior systems without making such braking adjustments, there is likely to an inconsistent level of torque on the bobbin and tension on the wire throughout the procedure. In the present system, improved product quality may be achieved, e.g., for a cable being manufactured downstream, due to the predictability of a substantially constant tension being imparted to the wire as it withdrawn from the bobbin.

As a further advantage, the substantially constant tension of the wire is maintained without the use of electrical or pneumatic inputs. Such inputs may yield cost and complexity to the system. Further, additional components, such as slip rings, rotary unions, batteries and the like, may be required with such systems. The present embodiments provide a highly reliable and cost effective solution without such equipment.

As yet a further advantage, the present embodiments are especially useful for high-speed equipment, for example, up to 3,100 rpm. Slip rings, rotary unions, and the like may be difficult or impossible to operate for such high speeds, and may render downtime and maintenance concerns. Such high-speed operational issues are reduced or eliminated in the present system.

Characteristics of the springs 54a, 54b, 82 and 84, and in particular their respective spring constants, may be selected for a specific material, wire size and/or bobbin specification. In a preferred embodiment, the springs 82 and 84 of the adjustment assembly 70 have a higher spring constant than the springs 54a and 54b of the brake assembly.

In one embodiment, the springs 82 and 84 of the adjustment assembly 70 comprise non-linear springs. Non-linear springs are desirable because the relationship between mass and diameter of the bobbin 40 is not linear. In other words, the springs 82 and 84 are pressed downward based on the mass of the bobbin 40 and related components, but regulation is desirable to account for the diameter of wire on the bobbin during withdrawal (and related torque), as explained above. In short, non-linear springs 82 and 84 for the adjustment assembly 70 help bridge the gap between these two parameters being taken into account. In contrast, linear springs may be suitable for springs 54a and 54b of the brake assembly.

It will be appreciated that other springs, such as air springs, polymer elastic springs, lead springs and the like, may be used in lieu of the springs 54a, 54b, 82 and 84 without departing from the scope of the present embodiments. Moreover, while two springs 82 and 84 are shown in connection with each of the adjustment assemblies 70a and 70b, it will be appreciated that one, or three or more, springs may be used for each adjustment assembly.

Finally, it will be appreciated that while one exemplary application has been described with respect to withdrawal of wire from a bobbin, the braking and regulation system of the present embodiments may be used in other applications. For example, and without limitation, another suitable application is where paper is being withdrawn from a bobbin, e.g., in a printing operation.

While various embodiments of the invention have been described, the invention is not to be restricted except in light of the attached claims and their equivalents. Moreover, the advantages described herein are not necessarily the only advantages of the invention and it is not necessarily expected that every embodiment of the invention will achieve all of the advantages described.

We claim:

1. A system for imparting a force during operation of a wire bobbin, comprising:
a main shaft for receiving a wire bobbin;
a brake element operably coupled to the main shaft;
an adjustment assembly comprising an adjustment block and at least one adjustment spring, wherein the at least one adjustment spring is biased to provide a force on the adjustment block in a vertically-upward direction,
wherein the adjustment block is operably coupled to the main shaft, such that a mass of the main shaft imposed upon the adjustment block combined with resistance of the at least one adjustment spring determines a vertical position of the main shaft and the brake element; and
a brake assembly that provides a brake force on the brake element, wherein the brake force is imparted to the main shaft via the brake element.

2. The system of claim 1, wherein the brake element comprises a brake disk that is fixed relative to the main shaft such the brake disk rotates when the main shaft rotates.

3. The system of claim 2, wherein the brake assembly comprises a vertically-movable brake pad and at least one brake spring, wherein the brake spring provides a brake force on the brake pad such that the brake pad engages the brake disk.

4. The system of claim 3, further comprising a support rod having a first region coupled to a fixed segment of a cradle, and the support rod having a second region coupled to the brake pad, wherein the brake spring is disposed around the support rod between the fixed segment of the cradle and the brake pad.

5. The system of claim 4, wherein the fixed segment of the cradle is disposed vertically beneath the brake disk, such that the brake spring is biased to provide an upward force upon the brake pad to engage the brake disk.

6. The system of claim 1, wherein the adjustment assembly further comprises at least one guide having a first region coupled to a fixed segment of a cradle, and wherein the guide extends through an aperture of the adjustment block such that the adjustment block is vertically movable along the guide.

7. The system of claim 6, wherein the adjustment spring is disposed around the guide between the fixed segment of the cradle and the adjustment block.

8. The system of claim 6, wherein the adjustment assembly comprises first and second guides disposed in a spaced-apart relation to one another, wherein each of the first and second guides extends through a respective aperture of the adjustment block.

9. The system of claim 1, wherein the adjustment assembly is positioned laterally outside of the brake element.

10. The system of claim 1, further comprising a locking collar coupled to the main shaft and configured to secure the bobbin in a lateral position along a length of the main shaft.

11. A method for imparting a force during operation of a wire bobbin, comprising:
providing a wire bobbin disposed around a main shaft, wherein the main shaft is coupled to an adjustment assembly comprising an adjustment block and at least one adjustment spring, wherein a mass of the main shaft imposed upon the adjustment block combined with resistance of the at least one adjustment spring determines a vertical position of the main shaft;
operating the wire bobbin in a first operational state, wherein there is a first quantity of wire around the bobbin in the first operational state, and wherein a first brake force is imparted to the main shaft in the first operational state; and
operating the wire bobbin in a second operational state, wherein there is a second quantity of wire around the bobbin in the second operational state, the second quantity of wire being less than the first quantity due to withdrawal of wire from the bobbin,
wherein a second brake force is imparted to the main shaft in the second operational state, the second brake force being less than the first brake force.

12. The method of claim 11, wherein the first and second brake forces are applied to a brake disk that is fixed relative to the main shaft such the brake disk rotates when the main shaft rotates.

13. The method of claim 12, further comprising using a brake assembly to apply the first and second brake forces to the brake disk, the brake assembly comprising a vertically-movable brake pad and at least one brake spring, wherein the brake spring provides a brake force on the brake pad such that the brake pad engages the brake disk.

14. The method of claim 11, wherein the adjustment assembly comprises at least one guide having a first region coupled to a fixed segment of a cradle, and wherein the guide extends through an aperture of the adjustment block such that the adjustment block is vertically movable along the guide.

15. The method of claim 11, further comprising engaging a locking collar around the main shaft to secure the bobbin in a lateral position along a length of the main shaft.

16. A system for imparting a force during operation of a wire bobbin, comprising:
a main shaft for receiving a wire bobbin;
a brake disk, wherein the brake disk is fixed relative to the main shaft such the brake disk rotates when the main shaft rotates;
an adjustment assembly comprising an adjustment block and at least one adjustment spring, wherein the at least one adjustment spring is biased to provide a force on the adjustment block in a vertically-upward direction,
wherein the adjustment block is operably coupled to the main shaft, such that a mass of the main shaft imposed upon the adjustment block combined with resistance of the at least one adjustment spring determines a vertical position of the main shaft and the brake disk; and
a brake assembly comprising a vertically-movable brake pad and at least one brake spring, wherein the brake spring provides a brake force on the brake pad such that the brake pad engages the brake disk.

17. The system of claim 16, further comprising a support rod having a first region coupled to a fixed segment of a cradle, and the support rod having a second region coupled to the brake pad, wherein the brake spring is disposed around the support rod between the fixed segment of the cradle and the brake pad.

18. The system of claim 17, wherein the fixed segment of the cradle is disposed vertically beneath the brake disk, such that the brake spring is biased to provide an upward force upon the brake pad to engage the brake disk.

19. The system of claim 16, wherein the adjustment assembly further comprises at least one guide having a first region coupled to a fixed segment of a cradle, and wherein the guide extends through an aperture of the adjustment block such that the adjustment block is vertically movable along the guide.

20. The system of claim 19, wherein the adjustment spring is disposed around the guide between the fixed segment of the cradle and the adjustment block.
